(19) United States
(12) Patent Application Publication
(10) Pub. No.: US 2016/0129434 A1
(43) Pub. Date: May 12, 2016

(54) METAL MESH PANEL FOR PASSIVE POLLUTION CONTROL APPLICATIONS

(71) Applicant: CAMBRIDGE INTERNATIONAL INC., Cambridge, MD (US)

(72) Inventors: Grace POKOO-AIKINS, Westover, MD (US); Robert E. MAINE, JR., Salisbury, MD (US)

(73) Assignee: CAMBRIDGE INTERNATIONAL INC., Cambridge, MD (US)

(21) Appl. No.: 14/934,328

(22) Filed: Nov. 6, 2015

Related U.S. Application Data
(60) Provisional application No. 62/076,087, filed on Nov. 6, 2014.

(51) Int. Cl. B01J 35/04; B01J 37/34; B01J 37/02; B01J 21/06; B01J 35/00

(52) U.S. Cl. CPC B01J 35/04; B01J 21/063; B01J 35/004; B01J 37/0215; B01J 37/34

(57) ABSTRACT

A mesh for passive pollution control includes a mesh panel having a surface defining a plurality of openings; and a layer of titanium dioxide coated onto at least a portion of the surface of the mesh panel; wherein the layer of titanium dioxide promotes degradation and destruction of pollutants through a process of photo-catalytic oxidation.

### TECHNICAL FIELD

The disclosure herein relates to a mesh panel for passive pollution control, and more particularly to a mesh panel configured to promote degradation and destruction of pollutants through a process of photo-catalytic oxidation.

### BACKGROUND

It is known that woven metal mesh products made from both round wire and flat strip have been commonly used for ornamental and fall protection purposes on a variety of types of outdoor structures. Many different patterns and mesh densities are available and can be chosen to match the desired aesthetics of the overall structure. More particularly, architectural mesh panels add an aesthetic look to a building façade while also adding additional benefits such as security, fall protection, and ventilation. Large mesh panels such as those spanning the heights of a building can be used, for example, on parking garages in order to improve the appearance thereof. These large mesh panels are typically manufactured from a flexible mesh, such as that utilized in conveyor belts, and require a tensioning system to apply pre-tension to the mesh panel in order to keep the mesh taught so that it can withstand large wind loads. An example of such an architectural mesh system is shown in U.S. Pat. No. 7,779,888 to Cambridge International, Inc., the contents of which are hereby incorporated by reference.

It is also understood from scientific literature that the exposure of known air pollutants such as volatile organic compounds (VOCs) to a surface coated with or containing titanium dioxide (TiO₂) in the presence of ultraviolet light will cause the degradation and destruction of those pollutants through the process of photo-catalytic oxidation, a process that is currently used widely in indoor air cleaners. In a similar manner, it is also known that this inherently passive process can also be highly effective at oxidizing and removing nitrogen oxides (NOₓ), a common air pollutant originating from automobile exhaust emissions.

### SUMMARY

A mesh for passive pollution control includes a mesh panel having a surface defining a plurality of openings; and a layer of titanium oxide coated onto at least a portion of the surface of the mesh panel; wherein the layer of titanium oxide promotes degradation and destruction of pollutants through a process of photo-catalytic oxidation.

### BRIEF DESCRIPTION OF THE DRAWINGS

These and other features, and advantages of the claimed invention will become more readily apparent to those skilled in the art upon reading the following detailed description, in conjunction with the appended drawings in which:

FIG. 1 is a plan view of a mesh panel according to an exemplary embodiment of the disclosure.

FIG. 2 is a further plan view of a mesh panel according to the exemplary embodiment of the disclosure.

FIG. 3 is a plan view of a mesh panel according to a further exemplary embodiment of the disclosure.

FIG. 4 is a plan view of a mesh panel according to a further exemplary embodiment of the disclosure.

### DETAILED DESCRIPTION

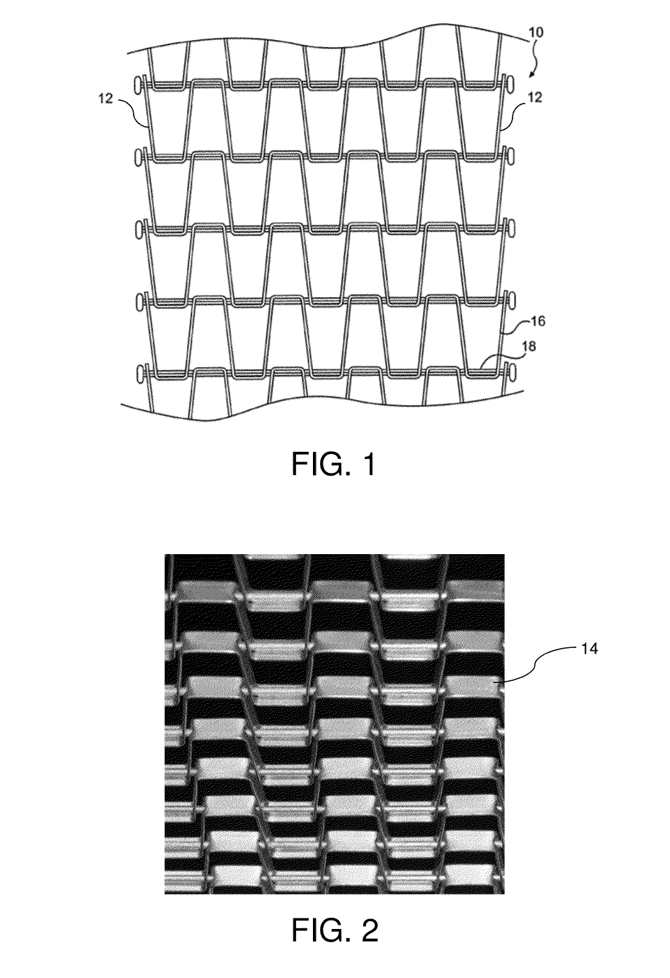

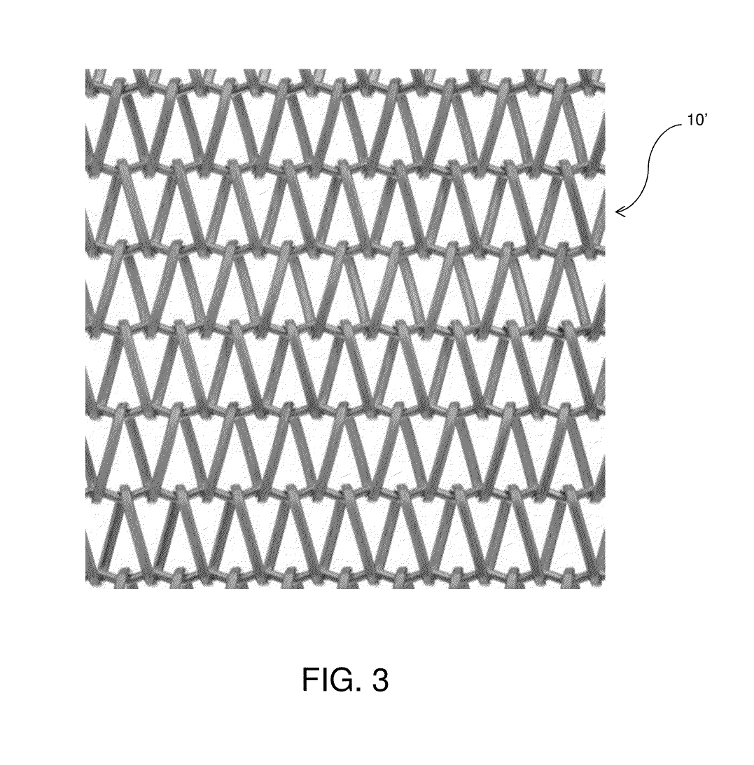

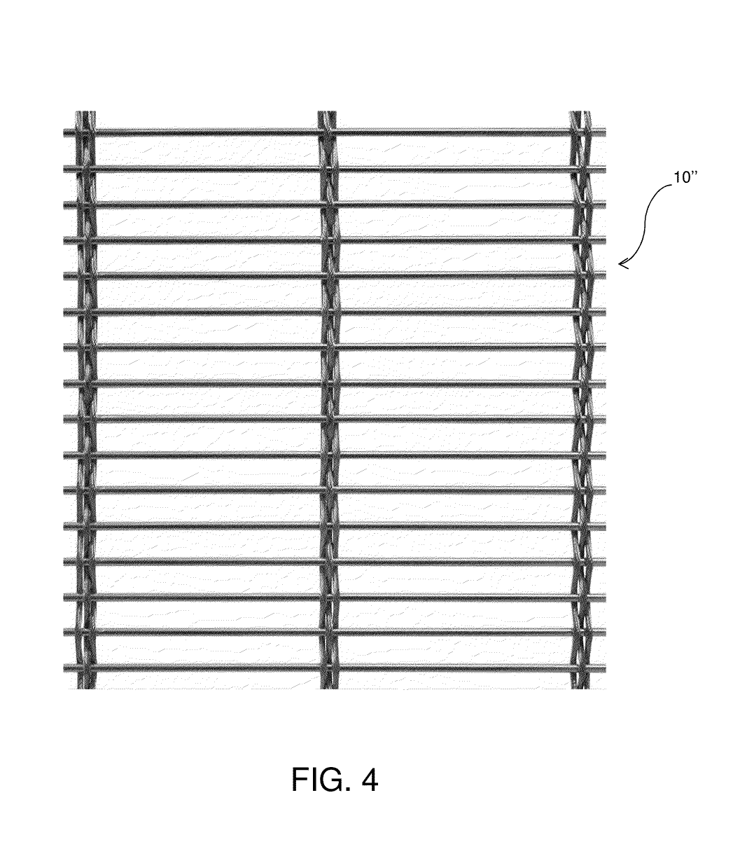

Referring to FIGS. 1 and 2, a first exemplary embodiment of mesh 10 is illustrated. Mesh 10 comprises a plurality of pickets 16, sometimes also referred to as wickets, and interconnecting rods 18 about which the pickets hinge. The pickets 16 on mesh 10 define a surface of the mesh 10 and the rods 18 are utilized to hold the components of mesh 10 together. Mesh 10 preferably comprises a metal mesh and more particularly, a flat wire metal mesh. Other types of mesh may also be utilized in accordance with the disclosure, such as, for example, a woven wire metal mesh 10′ as shown in FIG. 3 and a cable rod mesh 10″ as shown in FIG. 4.

The disclosure herein is directed to a variation of the above-described existing mesh products commonly used on parking garages and other outdoor structures. In accordance with an exemplary embodiment of the disclosure, mesh 10, 10′, 10″ is coated with a layer 12 of titanium dioxide (TiO₂) to provide passive air pollution control characteristics to the mesh 10, 10′, 10″ utilizing the process of photo-catalytic oxidation. That is, layer 12 promotes degradation and destruction of pollutants through a process of photo-catalytic oxidation when exposed to ultraviolet light. The layer 12 of titanium dioxide (TiO₂) can be applied to mesh of any of the various types currently known.

The layer 12 of titanium dioxide (TiO₂) is preferably applied to the entirety of the mesh surfaces in an assembled state, on both sides thereof. Alternatively, only a portion of the mesh 10, 10′, 10″ may be coated. The layer 12 may be applied by a spray coat application and then cured, a type of electrostatic application could also be used, or any other known application process could be utilized.

While having a relatively large amount of open area to permit airflow and light to pass, metal mesh panels 10, 10′, 10″ also provide a large amount of contact surface area for the TiO₂ coating, thus enhancing their effectiveness for large scale passive pollution control. More particularly, as shown in FIG. 2, each of the pickets 16 in mesh 10 has a predetermined width 14 providing a coating surface in the width direction of the mesh.

Parking garages are particularly suitable for application of the mesh panels 10, 10′, 10″ disclosed herein because the coated mesh can be located in close proximity to the source of the air pollutants. Furthermore, the natural flow of air through the building structure of parking garage aides in exposing the mesh panels to the air pollutants, while the structure's exposure to sunlight provides UV light as the catalyst for photo-catalytic oxidation to occur.

Further, periodic rainfall and the subsequent rinsing of the mesh 10 provides an important restorative aspect to the mesh coating layer 12 which helps to maintain its long term effectiveness at removing air pollutants.

Although certain exemplary embodiments of the disclosure have been shown and described in detail, it should be understood that various changes and modifications may be made therein without departing from the scope of the appended claims.

1. A mesh for passive pollution control comprising:
a mesh panel having a surface defining a plurality of openings; and
a layer of titanium dioxide coated onto at least a portion of the surface of the mesh panel;
wherein the layer of titanium dioxide promotes degradation and destruction of pollutants through a process of photo-catalytic oxidation.

2. The mesh according to claim 1, wherein the mesh panel is a metal mesh.

3. The mesh according to claim 2, wherein the mesh panel is a flat wire mesh.

4. The mesh according to claim 2, wherein the mesh panel is a woven wire mesh.

5. The mesh according to claim 2, wherein the mesh panel is a cable rod mesh.

6. The mesh according to claim 1, wherein the layer of titanium dioxide is coated onto an entirety of the surface of the mesh panel.

7. A method of manufacturing a mesh for passive pollution control comprising:
providing a mesh panel having a surface defining a plurality of openings; and
applying a layer of titanium dioxide onto at least a portion of the surface of the mesh panel, wherein the layer of titanium dioxide promotes degradation and destruction of pollutants through a process of photo-catalytic oxidation.

8. The method according to claim 7, wherein said applying step includes spray coating the layer of titanium dioxide.

9. The method according to claim 7, wherein said applying step includes electrostatic application of the layer of titanium dioxide.
